(19) United States
(12) Patent Application Publication
(10) Pub. No.: US 2026/0328161 A1
(43) Pub. Date: Oct. 22, 2026

(54) THRUST-REVERSAL SYSTEM FOR AN AIRCRAFT TURBOJET ENGINE, NACELLE AND PROPULSION ASSEMBLY INCLUDING SUCH A SYSTEM

(71) Applicant: Safran Nacelles, GONFREVILLE L'ORCHER (FR)

(72) Inventors: Loïc CHAPELAIN, MOISSY CRAMAYEL (FR); Patrick GONIDEC, MOISSY CRAMAYEL (FR); François BELLET, MOISSY CRAMAYEL (FR); Philippe WIERTEL, MOISSY CRAMAYEL (FR); Patrick André BOILEAU, MOISSY-CRAMAYEL (FR); Julien CHANDELIER, MOISSY-CRAMAYEL (FR)

(73) Assignee: Safran Nacelles, GONFREVILLE L'ORCHER (FR)

(21) Appl. No.: 19/715,894

(22) Filed: Jun. 22, 2026

Related U.S. Application Data
(63) Continuation of application No. PCT/FR2024/051732, filed on Dec. 19, 2024.

(30) Foreign Application Priority Data
Dec. 22, 2023 (FR) 23/15072

(51) Int. Cl. F02K 1/72

(52) U.S. Cl. CPC F02K 1/72; F05D 2220/323; F05D 2240/14; F05D 2260/54

(57) ABSTRACT

A thrust-reversal system for an aircraft turbojet engine defines a secondary duct. The thrust-reversal system includes an internal fixed structure and an external fixed structure connected together at a bifurcation defined on either side by a wall of the internal fixed structure. The thrust-reversal system includes at least one movable cowl, a set of air deflection structures and at least one blocking membrane. The movable cowl is movable between a retracted position and a deployed position. The blocking membrane is movable between a retracted position and a deployed position. The blocking membrane is also fastened, at rear fastening points, to at least one fastening element fixed relative to the outer fixed structure and, at front fastening points, to deployment structures.

### CROSS-REFERENCE TO RELATED APPLICATIONS

This application is a continuation of International Application No. PCT/FR 2024/051732, filed on Dec. 19, 2024, which claims priority to and the benefit of French Application No. FR 23/15072 filed on Dec. 22, 2023. The disclosures of the above applications are incorporated herein by reference.

### FIELD

The present disclosure relates to the field of nacelles and thrust reversers for an aircraft propulsion unit, and, more particularly, to thrust reversers equipped with deployable membranes.

### BACKGROUND

The statements in this section merely provide background information related to the present disclosure and may not constitute prior art.

Thrust reversers are systems making it possible to divert the air flow passing through the propulsion unit forward, so as to shorten landing distances and limit the stress on the brakes at the landing gears.

The cascade thrust reversers currently used in the aeronautical sector generally comprise cascade vanes integrated into a fixed structure of the thrust reverser, intended to be connected to a turbomachine casing. A movable structure of the thrust reverser includes one or several thrust reverser movable cowls, and it is mounted movably in translation relative to the fixed structure between a forward direct thrust position, and a rearward thrust reverser position. In the forward direct thrust position, the cascade vanes are arranged in a cavity of the thrust reverser movable cowls, and they are isolated from the secondary flow path of the propulsion unit by a radially inner wall of the thrust reverser cowls. On the other hand, in the rearward thrust reverser position, the rearward radially inner wall of the thrust reverser cowls defines an opening for the passage of the secondary flow path towards the cascade vanes.

To divert at least part of the secondary flow towards this passage opening in the direction of the cascades, the thrust reverser is generally equipped with blocking flaps, which, when deployed, at least partially block the secondary flow path. In a known way, this forces the air of the secondary flow to pass through the passage opening and reach the cascades, which then generate the forward counter-thrust air flow.

The blocking flap-based solution is also known to be relatively heavy and bulky. However, climate change is a major concern for many legislative and regulatory bodies around the world. Indeed, various restrictions on carbon emissions have been, are being, or will be adopted by various states. In particular, an ambitious standard applies both to new types of aircraft and to those already in service, resulting in the implementation of technological solutions to bring them into compliance with current regulations. Civil aviation has been taking action for several years now to contribute to the fight against climate change.

Consequently, work has been undertaken to reduce its negative climate impact by using methods and operating virtuous development and manufacturing processes that reduce greenhouse gas emissions as much as possible to reduce the environmental footprint of its activity.

In this regard, solutions have been developed for blocking the secondary flow path using one or several deployable membranes. Such a membrane design is, for example, known from document FR 3 076 864 A1.

The deployment of a blocking membrane can be carried out using one or several deployment connecting rods, one radially outer end of which is connected to one end of the membrane, and one radially inner end of which is articulated to a radially inner delimiting wall of the secondary flow path, this wall being part of the fixed structure of the thrust reverser.

When the movable structure moves towards its rearward thrust reverser position, the membrane gradually deploys into the flow path by plunging radially inward therein, driven by the connecting rod(s) which tilt downstream and also radially inward.

In the direct jet position, the end of the membrane connected to the connecting rods is generally clamped between a deflection edge of the fixed structure and an upstream end of the radially inner wall of the movable cowl.

The solution for deploying and removing the blocking membrane using connecting rods is satisfactory, however, it still remains capable of improvement. Indeed, in the thrust reverser configuration, the position of the inclined connecting rods in the secondary flow path is not known with great precision, nor is that of the membrane end connected to these connecting rods, in particular with regard to the connecting rods located in the immediate vicinity of the bifurcations. Thus, the distance between the blocking membrane and the inner fixed structure of the nacelle is not always maintained at a value providing an improved operation of the thrust reverser system, since the level of leakage generated by the membrane is not optimized.

### SUMMARY

This section provides a general summary of the disclosure and is not a comprehensive disclosure of its full scope or all of its features.

The present disclosure provides a thrust reverser system including a blocking membrane making it possible to finely manage the position of the membrane in the flow path, and therefore to precisely adjust the level of leakage generated by the membrane when it is deployed in the secondary flow path.

The present disclosure relates to a thrust reverser system for an aircraft turbojet engine nacelle. The thrust reverser system defining a secondary flow path for the passage of a secondary flow of the turbojet engine. The thrust reverser system includes an inner fixed structure and an outer fixed structure connected to each other at a bifurcation. The bifurcation being defined on either side by a bifurcation wall formed by the inner fixed structure. The thrust reverser system including: at least one movable cowl, movable between a retracted position, in which the thrust reverser system is in a direct jet configuration, and a deployed position, in which the thrust reverser system is in a reverse jet configuration; a set of air diverting structures; at least one blocking membrane, movable between a retracted position corresponding to the retracted position of the movable cowl, in which it is at least partially housed in an inner space of the movable cowl, and a deployed position corresponding to the deployed position of the movable cowl, in which it is at least partially deployed in the secondary flow path, so as to divert a major portion of the secondary flow towards the air diverting structures; the blocking membrane being fastened, at rear fastening points, to at least one fastening element fixed relative to the outer fixed structure and, at front fastening points, to deployment structures; the deployment structures comprising, for the or for each blocking membrane, at least a first traction cable and a second traction cable, the first and second traction cables each having a first end connected to the front fastening point of the blocking membrane closest to the corresponding bifurcation wall, and a second end located outside the secondary flow path and connected to a pulling system, each traction cable penetrating into the secondary flow path through a respective orifice provided in the inner fixed structure, the pulling system making it possible to pull the second end of the corresponding traction cable during deployment of the thrust reverser structure, so as to reduce the distance between the first end of the traction cable and the corresponding passage orifice.

Thus, by providing a traction cable near each bifurcation, it is possible, at each cable, to precisely fasten the distance between the blocking membrane and the inner fixed structure of the nacelle when the reverser system is deployed. Thus, the position of the end of the membrane is precisely fastened, which in particular makes it possible to finally adjust the level of leakage generated by the membrane during the thrust reversal phases.

The thrust reverser system according to the present disclosure may include one or more of the following optional features, considered alone or in all possible combinations.

According to one feature, the pulling system includes a support for fastening the second end of the traction cable, the fastening support being fixed relative to the movable cowl.

According to one feature, the traction cable is connected to the pulling system by a structure of variable length, for example an elastic return structure.

According to one feature, the pulling system includes a deflection structure secured to the movable cowl, the second end of the traction cable being secured to a fastening support fixed relative to the outer fixed structure of the thrust reverser system, the deflection structure including for example a pulley.

According to one feature, the pulling system includes a spring, such as a gas spring, or a pneumatic cylinder.

According to one feature, the thrust reverser system includes a guiding system configured to constrain the run of the traction cable outside the secondary flow path.

According to one feature, the guiding system includes at least one deflection system, including for example one or more pulleys.

According to one feature, the guiding system includes a sheath in which a part of the traction cable is inserted.

According to one feature, the deployment structures include passive deployment structures, of fixed length, a first end of which is secured to the inner fixed structure, and a second opposite end of which is secured to a front fastening point of the blocking membrane, the passive deployment structures being for example connecting rods or cables.

According to one feature, the thrust reverser system includes at least one additional traction cable, the additional traction cable being associated with one of the passive deployment structures which are not associated with the first and second traction cables.

The present disclosure also relates to a nacelle including a thrust reverser system in accordance with that defined above.

The present disclosure also relates to a propulsion unit including a bypass turbojet engine and a nacelle in accordance with that defined above, as well as an aircraft including at least one such propulsion unit.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a propulsion unit for an aircraft, including a bypass turbojet engine and a nacelle incorporating a cascade thrust reverser system, the thrust reverser system being represented in a retracted configuration in accordance with one form of the teachings of the present disclosure;

FIG. 2 is a perspective view of the propulsion unit of FIG. 1, with the thrust reverser system represented in a deployed configuration;

FIG. 3 is a partial perspective view of the propulsion unit in accordance with that of FIG. 1, the nacelle incorporating a reverser system with deflector membranes, the thrust reverser system being in a deployed configuration;

FIG. 4 is a partial perspective view of a rear section of the nacelle of FIG. 1, with the thrust reverser system in a retracted configuration;

FIG. 5 is a partial perspective view of the rear section of the nacelle of FIG. 1, with the thrust reverser system in a deployed configuration;

FIG. 6 is a schematic cross-sectional view of a part of the nacelle of FIG. 3 with the thrust reverser system in a retracted position;

FIG. 7 is a schematic cross-sectional view of a part of the nacelle of FIG. 3, with the thrust reverser system represented during deployment, in a first intermediate position;

FIG. 8 is a schematic cross-sectional view of a part of the nacelle of FIG. 3, with the thrust reverser system represented during deployment, in a second intermediate position;

FIG. 9 is a schematic cross-sectional view of a part of the nacelle of FIG. 3, with the thrust reverser system represented in the deployed position;

FIG. 10 is a schematic cross-sectional view of a part of the nacelle of FIG. 3, showing a fastening variant of the first end of the traction cable;

FIG. 11 is a schematic cross-sectional view of a part of the nacelle of FIG. 3, showing a fastening variant of the second end of the traction cable, with the thrust reverser system in the retracted position;

FIG. 12 is a schematic cross-sectional view of a part of the nacelle of FIG. 3, showing the fastening variant of the second end of the traction cable, with the thrust reverser system in the deployed position;

FIG. 13 is a schematic cross-sectional view of a part of the nacelle of FIG. 3, showing a system for guiding the traction cable including fixed pulleys, with the thrust reverser system in the retracted position;

FIG. 14 is a schematic cross-sectional view of a part of the nacelle of FIG. 3, showing the system for guiding the traction cable including fixed pulleys, with the thrust reverser system in the deployed position;

FIG. 15 is a schematic cross-sectional view of a part of the nacelle of FIG. 3, showing a system for guiding the traction cable including at least one movable pulley, with the thrust reverser system in the retracted position;

FIG. 16 is a schematic cross-sectional view of a part of the nacelle of FIG. 3, showing the system for guiding the traction cable including at least one movable pulley, with the thrust reverser system in the deployed position;

FIG. 17 is a schematic cross-sectional view of a part of the nacelle of FIG. 3, showing a system for pulling the traction cable, with the thrust reverser system in the retracted position;

FIG. 18 is a schematic cross-sectional view of a part of the nacelle of FIG. 3, showing the system for pulling the traction cable, with the thrust reverser system in the deployed position;

FIG. 19 is a schematic cross-sectional view of a part of the nacelle of FIG. 3, showing a variant of the system for pulling the traction cable, with the thrust reverser system in the retracted position;

FIG. 20 is a schematic cross-sectional view of a part of the nacelle of FIG. 3, showing a variant of the system for pulling the traction cable, with the thrust reverser system in the deployed position; and

FIG. 21 is a partial perspective view of the rear section of the nacelle of FIG. 1, showing a variant of the thrust reverser system in which additional traction cables are provided.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

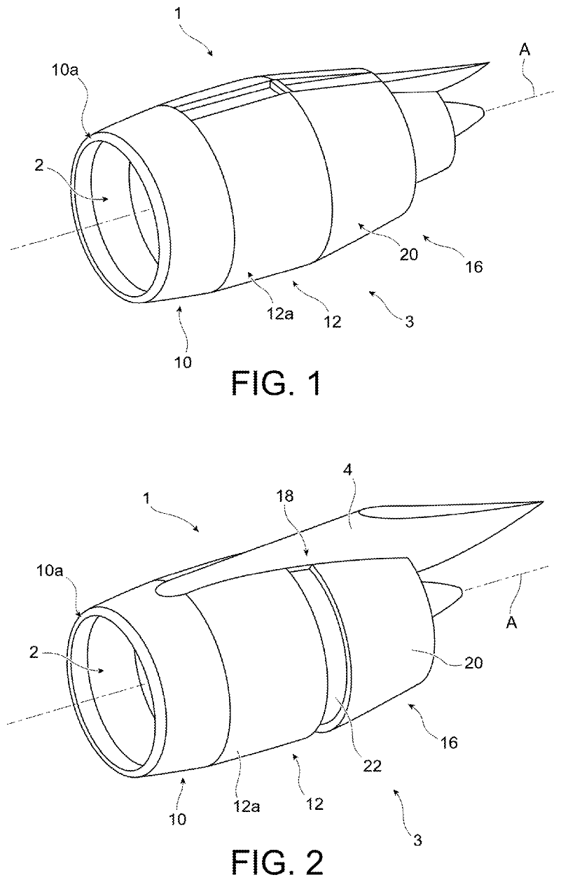

FIGS. 1 and 2 represent an aircraft propulsion unit 1, having a longitudinal central axis A.

Subsequently, the terms “upstream” and “downstream” are defined relative to a general direction of flow of gases through the propulsion unit, along the axis A when it generates thrust. These terms “upstream” and “downstream” could respectively be replaced by the terms “front” and “rear”, with the same meaning.

The propulsion unit 1 comprises a turbomachine 2 and a nacelle 3. The propulsion unit 1 is configured to be connected through a strut 4 to a wing (not represented) of an aircraft.

In this example, the turbomachine 2 is a bypass turbojet engine, including, in particular, a gas generator and a fan. The nacelle 3 comprises a front section 10 forming an air inlet 10a, a middle section 12 which includes two fan cowls 12a enclosing a fan casing of the turbojet engine, and a rear section 16.

In operation, an air flow enters the propulsion unit 1 through the air inlet 10a, passes through the fan of the turbojet engine, and then splits into a primary flow and a secondary flow. The primary flow flows in a primary gas circulation flow path passing through the gas generator of the turbojet engine 2. The secondary flow flows in a secondary flow path surrounding the gas generator. The secondary flow path is defined radially inwards by an inner structure of the nacelle that encloses the gas generator.

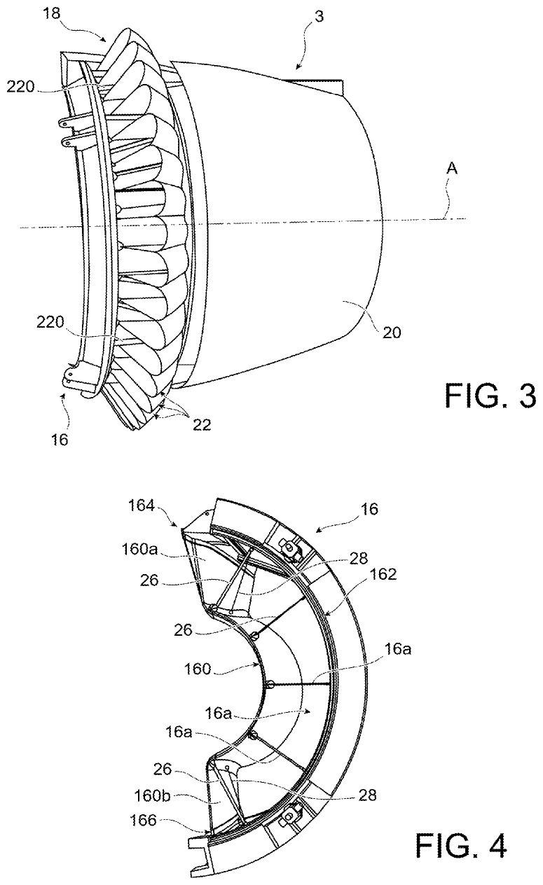

The rear section 16 of the nacelle incorporates a thrust reverser system 18. FIG. 1 shows the nacelle 3 in a direct jet configuration, that is to say with the thrust reverser system in the rearward position, while FIG. 2 shows the nacelle 3 in a reverse jet configuration, that is to say with the thrust reverser system in the deployed position. Thus, it can be seen in FIG. 3 that a movable cowl 20 of the rear section 16 is in the rearward position, revealing a set of air diverting structures 22, which, in the example of FIGS. 1 and 2, are cascade vanes.

FIG. 3 is a partial view of the rear section 16 of the nacelle 3 of the propulsion unit 1, in a variant in which the air diverting structures 22 are deflector membranes. As visible in FIG. 3, which shows the thrust reverser system 18 in the deployed position, the set of the deflector membranes 22 are deployed, so as to redirect the secondary air flow outside the nacelle 3, forward.

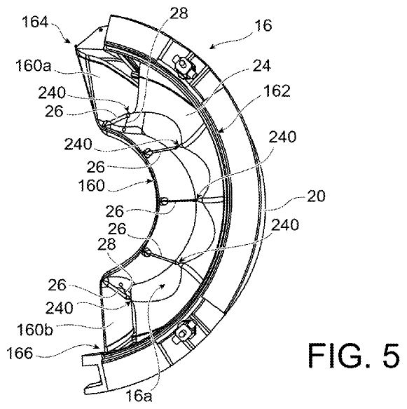

FIGS. 4 and 5 represent a half-part of the rear section 16 of the nacelle 3, which includes the thrust reverser system 18, the latter being respectively in the retracted configuration and in the deployed configuration.

As visible in FIG. 4, each half-part of the rear section 16 of the nacelle includes an inner fixed structure 160 (also called IFS) and an outer fixed structure 162 (also called OFS). In the example, the rear section 16 of the nacelle has a so-called “D-shaped” structure (commonly referred to as a “D-duct”). In such a configuration, the inner fixed structure and the outer fixed structure are connected to each other through two connecting islands (a first bifurcation 164 and a second bifurcation 166) disposed in the secondary flow path 16a, forming respectively the first bifurcation 164 and the second bifurcation 166. For a propulsion unit fastened to an aircraft wing, the first and second bifurcations 164, 166 are disposed respectively according to the so-called “twelve o'clock” (for the first bifurcation 164, or upper bifurcation 164) and “six o'clock” (for the second bifurcation 166, or lower bifurcation 166) positions. It is recalled that the “twelve o'clock” and “six o'clock” positions are conventionally defined by analogy with a watch dial, the nacelle being in the operating position, that is to say under the wing. The “twelve o'clock” position is thus located at the attachment strut of the nacelle, while the “six o'clock” position corresponds to the diametrically opposite position. For a propulsion unit fastened to the fuselage of an aircraft, the bifurcations will be disposed according to the so-called “three o'clock” and “nine o'clock” positions. Furthermore, although the nacelle described in the present application has a D-shaped structure, the present disclosure applies to all types of nacelles, and in particular to nacelles with an “O-shaped” or “C-shaped” structure, structures in which only one bifurcation is provided. Each bifurcation 164, 166 is defined at the secondary flow path 16a, on either side, by a bifurcation wall 160a, 160b formed by a part of the inner fixed structure 160 of the rear section 16.

In the configuration of FIGS. 1 and 4, the secondary flow path 16a is, at the rear section 16, defined by the inner fixed structure 160, and the movable cowls 20, which form part of the rear section 16 of the nacelle 3. The secondary flow path 16a is in a direct jet configuration and is improved to allow the secondary flow to pass towards the rear of the propulsion unit, offering the least possible resistance.

In the configuration of FIGS. 2, 3 and 5, the movable cowls 20 are in a rearward position and the secondary flow path 16a is at least partially blocked by a structure for blocking the secondary flow path, in the example a blocking membrane 24. In its deployed position, the blocking membrane 24 makes it possible to block part of the flow secondary to redirect it towards the air diverting structures 22 and therefore outward from the nacelle, thus generating the desired counter-thrust.

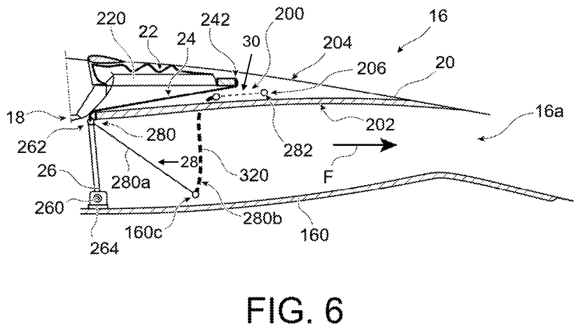

FIGS. 6 to 9 show a cross-section of the rear section 16 of the nacelle 3, when it is equipped with deflector membranes 22 such as those shown in FIG. 3.

FIG. 6 shows the thrust reverser system 18 in the retracted configuration, that is to say the nacelle 3 is in the direct jet configuration.

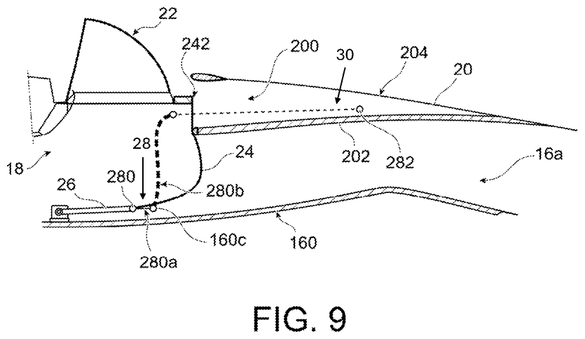

The thrust reverser system 18 comprises at least one movable cowl 20, in the example two movable cowls 20, which form the outer surface of the rear section 16 of the nacelle. The thrust reverser system 18 further comprises the air diverting structures 22 and the structures 24 for blocking the secondary flow path 16a. The thrust reverser system 18 includes actuators (not represented), in particular electromechanical actuators, making it possible to slide the movable cowl between a retracted position (FIG. 6) and a deployed position (FIG. 9), and vice versa. This transition occurs by a translational movement along the longitudinal axis of the nacelle, corresponding to the longitudinal axis A of the propulsion unit 1.

When the thrust reverser system 18 is in the retracted position (FIG. 6), the movable cowl 20 is in the retracted position, corresponding to a forward position in which the movable cowl 20 provides aerodynamic continuity with the middle section of the nacelle, and the blocking membrane 24 is in the retracted position, position in which it is at least partially housed in an inner space 200 of the corresponding movable cowl 20, located between an inner surface 202 and an outer surface 204 of the movable cowl 20.

When the thrust reverser system 18 is in the deployed position (FIG. 9), the movable cowl 20 is in the deployed position, corresponding to a rearward position, in which it exposes the diverting structures 22, in the example of the deflector membranes, the blocking membranes 24 are in the deployed position, position in which they at least partially block the secondary flow path 16a.

In this configuration, the action of the blocking membranes 24 and the deflector membranes 22 makes it possible to redirect the secondary flow outside the nacelle, forward, in order to create a counter-thrust. The passage into the deployed position of the blocking membranes 24 is obtained by the combined action of the aerodynamic forces generated by the secondary flow circulating in the secondary flow path 16a and deployment structures 26 attached to the inner fixed structure 160 of the nacelle.

The blocking membrane 24 is connected to the deployment structures 26, which are in the example connecting rods 26. Each connecting rod 26 is fastened and articulated to the inner fixed structure 160 of the nacelle. In the example, each connecting rod 26 is articulated at a first end 260, the first end 260 being rotatably mounted in a fitting 264 secured to the inner fixed structure 160 of the nacelle 3.

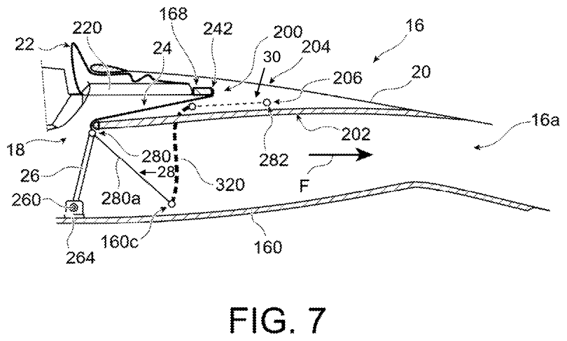

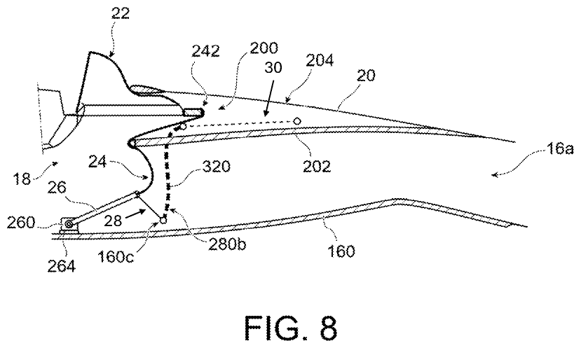

Each connecting rod 26 is fastened, at a second end 262 opposite the first end 260, to the blocking membrane 24 (see FIG. 6). Thus, as can be seen in FIGS. 7 and 8, which show intermediate positions of the movable cowl 20 between the retracted and deployed positions, during the movement of the latter towards the deployed position visible in FIG. 9, the retraction of the movable cowl 20 makes it possible to progressively release the blocking membrane 24, the latter being pushed backwards by the air flow circulating in the secondary flow path (represented by the arrow F), at the same time as the movable cowl 20 moves backwards. At the same time as the blocking membrane 24 is pushed backwards, it drives the second end 262 of each connecting rod 26, to which it is attached at front fastening points 240 (see FIG. 5), which causes a backward rotational movement of each connecting rod 26. This rotational movement drives the second end 262 of each connecting rod 26 towards the inner fixed structure 160, and therefore deploying the blocking membrane 24 in the secondary flow path.

The blocking membrane 24 is furthermore fastened, at rear fastening points 242, to one or several fastening elements 168, which are fixed relative to the outer fixed structure 162 of the rear section 16 of the nacelle. These fastening elements 168 are disposed downstream of the diverting structures 22. Thus, as visible in FIG. 9, when the thrust reverser system is deployed, the blocking membrane 24 is deployed in the secondary flow path, being retained, at the front fastening points 240, by the connecting rods 26 and, at an opposite end, at the rear fastening points 242, by the fastening elements 168.

As mentioned above, in the example of FIGS. 6 to 9, the air diverting structures are deflector membranes 22. As visible in FIG. 3, it is provided, between some or between each of the deflector membranes 22, a longitudinal upright 220. In the example of FIGS. 6 to 9, each fastening element 168 of the blocking membrane 24 is secured to one of these longitudinal uprights 220.

In the example of FIGS. 6 to 9, the connecting rods 26 are passive deployment structures 26, because they are driven from their retracted position (FIG. 6) to their deployed position (FIG. 9) by the action of the blocking membrane 24. The passive deployment structures 26 have a fixed length. They are connecting rods 26 as in the example of the figures, but the connecting rods 26 can be replaced by other structures, such as cables of fixed length.

According to the present disclosure, the passive deployment structures 26 which are located in the immediate vicinity of a wall 160a, 160b defining the single bifurcation (in the case of an “O-shaped” or “C-shaped” structure) or one of the first and second bifurcations 164, 166 (in the case of a “D-shaped” structure) are assisted by a deployment structure including a traction cable 28. In the example of the figures, these are the passive deployment structures 26 located in the immediate vicinity of the 12 o'clock and 6 o'clock positions, that is to say the deployment structures which are located closest respectively to the upper bifurcation 164 and the lower bifurcation 166, and therefore to the walls 160a and 160b. At least two traction cables 28 are thus provided per half-part of the rear section 16 of the nacelle, i.e., at least four traction cables 28 for the entire nacelle 3.

Each traction cable 28 includes a first end 280 which is secured directly or indirectly to a first fastening point 240 of the blocking membrane 24, being for example either fastened to the blocking membrane 24 or to the corresponding passive deployment structure 26. Each traction cable 28 includes, at an opposite end, a second end 282 which is linked to a pulling system 30. In the example of FIGS. 6 to 9, the pulling system 30 includes the movable cowl 20, the second end 282 of the traction cable 28 being fastened to a fastening support 206 secured to the movable cowl 20 and fixed relative to the latter.

Each traction cable 28 includes a first portion 280a, which is located in the secondary flow path 16a when the thrust reverser system is in the retracted position, and a second portion 280b, which is located inside the inner fixed structure 160 when the thrust reverser system is in the retracted position. As visible in FIG. 6, each traction cable 28 penetrates into the secondary flow path 16a through an orifice 160c provided in the corresponding wall 160a, 160b (or near this wall). As can be seen in FIGS. 6 to 9, the retraction of the movable cowl 20 during deployment of the thrust reverser system drives the second end 282 of each traction cable rearward, which amounts to pulling the cable through the corresponding orifice 160c, thus gradually reducing the distance between the corresponding orifice 160c and the first end 280 of each traction cable 28. The pulling of the cable will therefore make it possible to pull a part of the blocking membrane 24 towards the corresponding wall 160a, 160b of the inner fixed structure 160. This provides that the blocking membrane 24 deploys sufficiently at the bifurcations 164, 166 of the rear section 16. Furthermore, the traction cables 28 make it possible to finely adjust the final distance between the blocking membrane 24 and the inner fixed structure at the deployment structures 26 equipped with a traction cable 28. By finely adjusting this distance, it is possible to precisely manage the level of leakage generated by the blocking membrane 24, which is desired both to the proper operation of the turbojet engine and to the overall efficiency of the thrust reverser system.

The traction cables 28 are in one form non-stretchable, or very faintly stretchable cables. These are, for example, metal cables or cables made of a polymer material.

A system for guiding the cable 32 may be provided, over all or part of the run of the traction cable 28 between the orifice of the wall of the inner fixed structure and the second end 282 of the traction cable 28, fastened to the movable cowl 20. In the example of FIGS. 6 to 13, the guiding system 32 includes a sheath 320, for example a rigid, flexible or semi-rigid sheath.

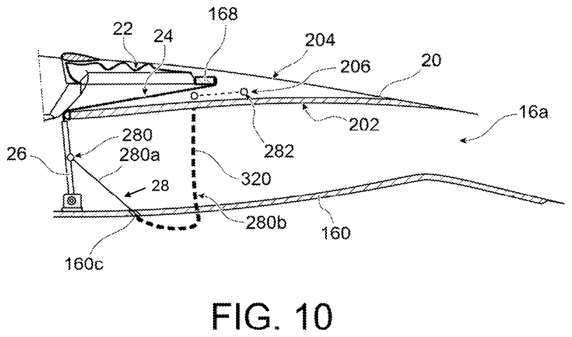

In a variant represented in FIG. 10, the traction cables 28 may be fastened to a respective passive deployment structure 26. In the example of FIG. 10, each traction cable 28 is fastened to the corresponding connecting rod 26, between the first and second ends 260a, 260b thereof.

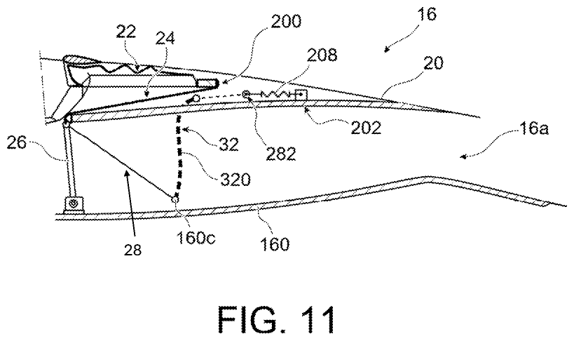

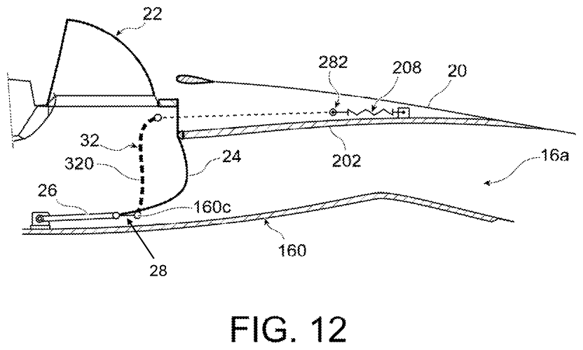

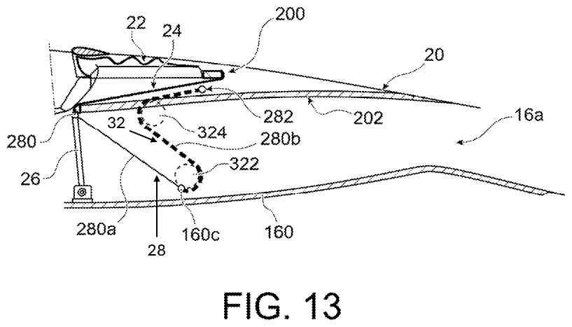

In a variant represented in FIGS. 11 and 12, the second end 282 of each traction cable 28 may be fastened to the corresponding movable cowl 20 through a structure of variable length, for example an elastic return structure such as a spring 208. Providing an elastic return structure makes it possible to compensate for part of the distance traveled by the movable cowl 20 between the retracted and deployed positions, when this distance is greater than the travel desired for the first end 280 of the traction cable 28. As can be seen in FIGS. 12 and 13, the elastic return structure is in the retracted position when the thrust reverser system 18 is in the retracted position, and is in the extended position when the thrust reverser system 18 is in the deployed position. Thus, the movable cowl 20 is able to move back even after the first end 280 of the traction cable 28 may no longer move back, the traction cable 28 being retained by the connecting rod 26.

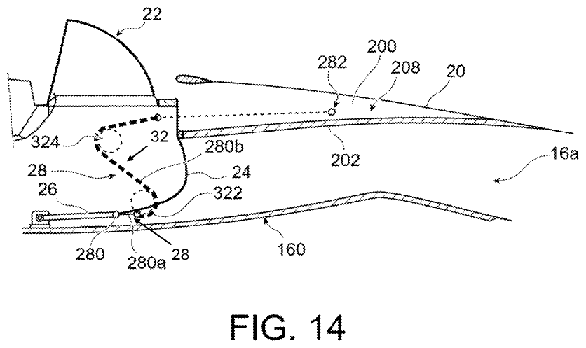

In a variant represented in FIGS. 13 and 14, the structure 32 for guiding the traction cable 28 includes at least one deflection system 322, 324, fixed relative to the inner fixed structure 160, the deflection system including in the example two pulleys 322, 324.

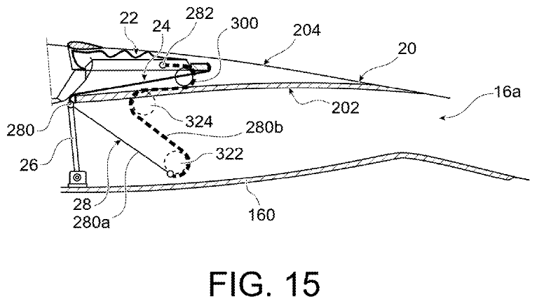

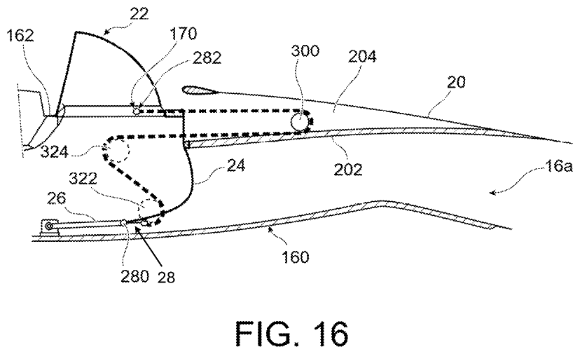

In a variant represented in FIGS. 15 and 16, the pulling system 30 includes at least one deflection structure 300, including in the example a movable pulley 300, which is fixed relative to the movable cowl 20. The second end 282 of the traction cable 28 is fastened to a fastening support 170 fixed relative to the outer fixed structure 162 of the nacelle. Providing a movable pulley 300 which is fixed relative to the movable cowl 20 makes it possible to reduce the travel of the first end 280 of the traction cable relative to the travel of the movable cowl 20. The movable pulley 300 may be associated with deflection pulleys (as shown in FIGS. 15 and 16) or with a sheath 320 (as shown in FIGS. 6 to 13).

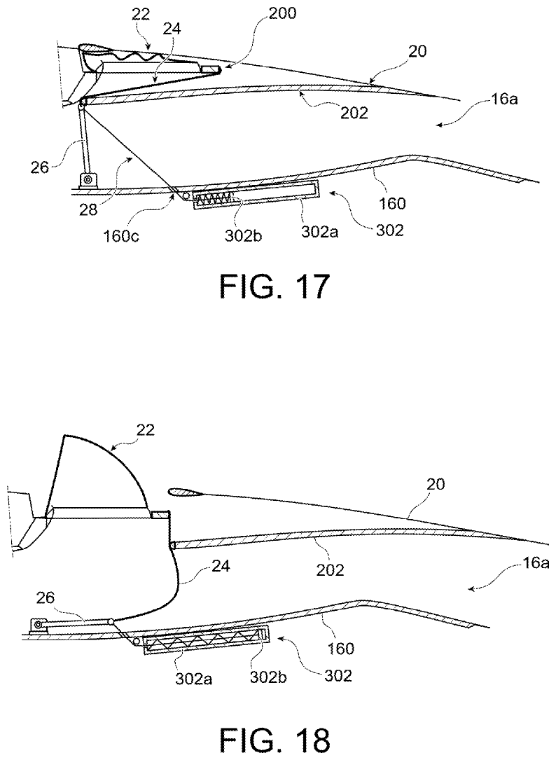

In a variant represented in FIGS. 17 and 18, the pulling system 30 may include a spring, such as a gas spring 302. In the example, the gas spring 302 includes a body 302a, inside which is disposed a movable piston 302b. The body 302a is fixed relative to the inner fixed structure 160, and the traction cable 28 is connected to the movable piston 302b. Thus, when the movable cowl 20 moves back, the movable piston 302b drives the traction cable 28.

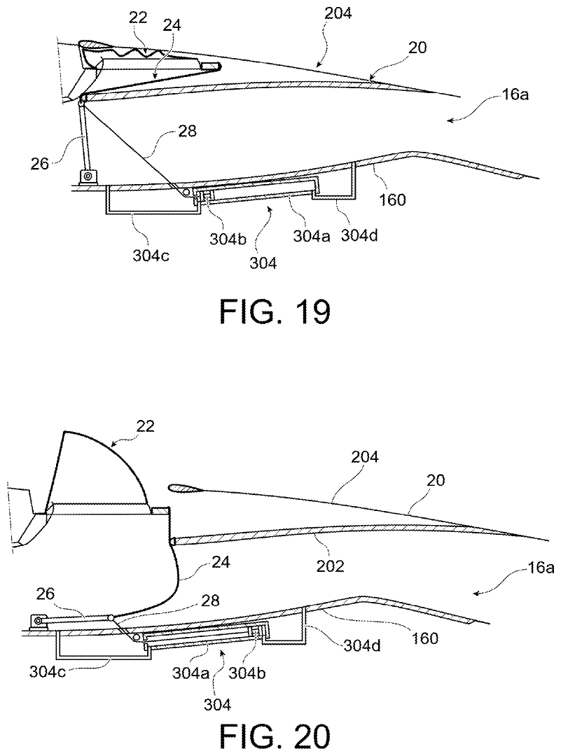

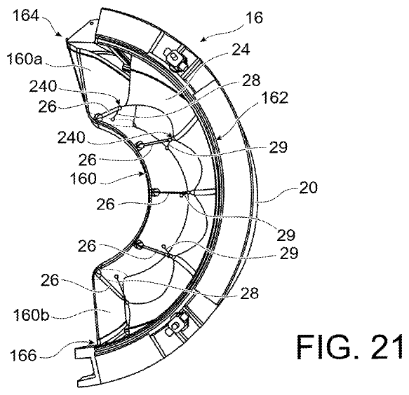

In a variant represented in FIGS. 19 and 20, the pulling system 30 includes a pneumatic cylinder 304. The pneumatic cylinder 304 includes a body 304a inside which is disposed a movable piston 304b. The body 304a includes an air inlet 304c and an air outlet 304d, both in fluid communication with the secondary flow path. Thus, when the movable cowl 20 moves back, the movable piston 304b drives the traction cable 28, under the effect of the static pressure difference existing between the air inlet 304c and the air outlet 304d.

In a variant represented in FIG. 21, an additional traction cable 29 is provided at one or each connecting rod 26 not being associated with one of the first and second traction cables 28. The configuration and operation of the additional traction cables 29 are similar to those described above for the first and second traction cables 28.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A thrust reverser system for a nacelle of an aircraft turbojet engine, the thrust reverser system defining a secondary flow path for passage of a secondary flow of the aircraft turbojet engine, the thrust reverser system comprising:
an inner fixed structure and an outer fixed structure, the inner fixed structure and the outer fixed structure being connected at at least one bifurcation, the at least one bifurcation being defined on either side by a bifurcation wall formed by the inner fixed structure;
at least one movable cowl movable between a retracted position, in which the thrust reverser system is in a direct jet configuration, and a deployed position, in which the thrust reverser system is in a reverse jet configuration;
a set of air diverting structures; and
at least one blocking membrane movable between a retracted position corresponding to the retracted position of the at least one movable cowl and a deployed position corresponding to the deployed position of the at least one movable cowl to divert a portion of the secondary flow towards the set of air diverting structures, wherein the at least one blocking membrane is at least partially housed in an inner space of the at least one movable cowl and is at least partially deployed in the secondary flow path, wherein the at least one blocking membrane is fastened at rear fastening points to at least one fastening element fixed relative to the outer fixed structure and at front fastening points to deployment structures;
wherein the deployment structures comprising, for the at least one blocking membrane, a first traction cable and a second traction cable, the first traction cable and the second traction cable each having a first end connected to one of the front fastening points of the at least one blocking membrane closest to the bifurcation wall, and a second end located outside the secondary flow path and connected to a pulling system, each of the first traction cable and the second traction cable penetrating into the secondary flow path through a respective orifice provided in the inner fixed structure, the pulling system configured to pull the second end of each of the first traction cable and the second traction cable during deployment of the thrust reverser system, so as to reduce distance between the first end of each of the first traction cable and the second traction cable and the respective orifice.

2. The thrust reverser system according to claim 1, wherein the pulling system includes a support for fastening the second end of each of the first traction cable and the second traction cable, the support being fixed relative to the at least one movable cowl.

3. The thrust reverser system according to claim 2, wherein the first traction cable and the second traction cable are connected to the pulling system by a structure of variable length.

4. The thrust reverser system according to claim 3, wherein the structure of variable length is an elastic return structure.

5. The thrust reverser system according to claim 1, wherein the pulling system includes a deflection structure secured to the at least one movable cowl, the second end of each of the first traction cable and the second traction cable being secured to a fastening support fixed relative to the outer fixed structure of the thrust reverser system.

6. The thrust reverser system according to claim 5, wherein the deflection structure comprises a pulley.

7. The thrust reverser system according to claim 1, wherein the pulling system includes a spring, such as a gas spring, or a pneumatic cylinder.

8. The thrust reverser system according to claim 1, further comprising a guiding system configured to constrain a run of each of the first traction cable and the second traction cable outside the secondary flow path.

9. The thrust reverser system according to claim 8, wherein the guiding system includes at least one deflection system.

10. The thrust reverser system according to claim 9, wherein the at least one deflection system comprises one or more pulleys.

11. The thrust reverser system according to claim 8, wherein the guiding system includes a sheath into which a part of each of the first traction cable and the second traction cable is inserted.

12. The thrust reverser system according to claim 1, wherein the deployment structures include passive deployment structures, of fixed length, a first end of which is secured to the inner fixed structure, and a second opposite end is secured to a forward fastening point of the at least one blocking membrane.

13. The thrust reverser system according to claim 12, wherein the passive deployment structures are connecting rods or cables.

14. The thrust reverser system according to claim 12, further comprising at least one additional traction cable, the at least one additional traction cable being associated with one of the passive deployment structures which are not associated with the first traction cable and second traction cable.
